(19) United States
(12) Patent Application Publication
(10) Pub. No.: US 2008/0237535 A1
(43) Pub. Date: Oct. 2, 2008

(54) Composition for polishing semiconductor wafer, and method of producing the same

(75) Inventors: Kuniaki Maejima, Tokyo (JP); Masaru Nakajo, Tokyo (JP); Hiroaki Tanaka, Ayase-shi (JP)

Correspondence Address: Edwards Angell Palmer & Dodge LLP, P.O. Box 55874, Boston, MA, 02205, US

(73) Assignees: SpeedFam Co., Ltd., Kanagawa (JP); Nippon Chemical Industrial Co., Ltd., Tokyo (JP)

(21) Appl. No.: 12/076,316

(22) Filed: Mar. 17, 2008

(30) Foreign Application Priority Data
Mar. 19, 2007 (JP) 2007-71478

(51) Int. Cl. C09K 13/02; C09K 3/14

(52) U.S. Cl. 252/79.1; 51/308

(57) ABSTRACT

A composition for polishing a semiconductor wafer contains fumed silica particles that are produced by wet grinding using a grinding medium and that have characteristics (A) to (C):

(A) a specific surface area in the range of 50 to 200 m²/g measured by a BET method;
(B) an average particle diameter in the range of 10 to 50 nm measured by a laser light-scattering method; and
(C) an average ratio A/B of the major axis A to the minor axis B of the fumed silica particles in the range of 1.2 to 2.0 measured by TEM observation,
wherein the concentration of silica particles containing the fumed silica particles is in the range of 0.5 to 50 weight percent relative to the total weight of an aqueous dispersion.

### BACKGROUND OF THE INVENTION

1. Field of the Invention

The present invention relates to a composition for wafer polishing in which polishing is performed on a surface and an edge portion of a semiconductor wafer such as a silicon wafer or a semiconductor device substrate having a metal film, an oxide film, a nitride film, and the like (hereinafter referred to as “a metal film and the like”) thereon, and a method of producing the same. Furthermore, the present invention relates to a processing method of forming a mirror surface of a surface or an edge portion of a semiconductor wafer using the composition for wafer polishing.

2. Description of the Related Art

Electronic components such as ICs, LSIs, and VLSIs, which are made of a semiconductor material, e.g., silicon single crystal, as a raw material, are produced from a small piece of semiconductor element chip prepared by forming a large number of fine electrical circuits on a wafer, which is prepared by slicing an ingot of a single crystal of silicon or a compound semiconductor into a thin disc, and then separating the wafer into chips. The wafer prepared by slicing the ingot undergoes the steps of lapping, etching, and polishing, and is thereby processed into a mirror surface wafer whose surface and edge surface are mirror-finished. Fine electrical circuits are then formed on the mirror-finished surface of the wafer in the subsequent device processes. Recently, from the standpoint of an increase in the operation speed of LSIs, processes of forming wirings have been changed so as to form the following structure: The material of the wirings is changed from conventional aluminum (Al) to copper (Cu), which have a lower electrical resistance, and an insulating film provided between wirings is changed from a silicon oxide film to a low-dielectric-constant film having a lower dielectric constant. Furthermore, a barrier film made of tantalum or tantalum nitride for preventing copper (Cu) from diffusing into the low-dielectric-constant film is provided between the copper wiring and the low-dielectric-constant film. In order to form such a wiring structure and to increase the integration, a polishing step is often repeatedly performed for, for example, planarizing an interlayer insulating film, forming a metal connecting portion (plug) provided between wirings in a multilayer interconnection, and forming a buried wiring. In a method of performing this polishing of a surface, in general, a semiconductor wafer is placed on a surface plate covered with a polishing cloth made of a synthetic resin foam, a suede-like synthetic leather, or the like, and the semiconductor wafer is then rotated under pressure, while quantitatively supplying a solution of a polishing composition to polish the semiconductor wafer.

The edge surface is in a state in which a metal film and the like are irregularly deposited thereon. Before a wafer is separated into semiconductor element chips, the wafer undergoes a step of transferring and other steps while being supported at the edge portion thereof and the original disc shape of the wafer is maintained. If the outer circumferential edge of the wafer has an irregular shape during transferring, the following problems may occur. Microfractures due to contact with a transferring device may occur, thereby generating fine particles. Furthermore, contaminating particles may intrude into such a rough surface and be scattered in the subsequent steps, thereby contaminating a surface that has been subjected to high-precision processing. These problems significantly affect the yield and the quality of the semiconductor products. In order to avoid these problems, it is necessary to perform mirror-polish finishing on the edge portion after the formation of electrical circuits.

The above edge polishing is performed as follows using a polishing machine in which a polishing pad made of a synthetic resin foam, a synthetic leather, a nonwoven fabric, or the like is applied on the surface of a pad support, e.g., a rotatable drum. An edge portion of a wafer, which is a workpiece, is pressed onto the pad support in an oblique manner while the edge portion is rotated. The edge portion is polished while a solution of a composition for polishing containing abrasive grains, such as silica particles, is supplied. Examples of the abrasive grains of the composition for polishing used in this step include colloidal silica similar to that used for an edge polishing of a silicon wafer, fumed silica, ceria, and alumina, all of which are used in a surface polishing of a semiconductor wafer. In particular, colloidal silica and fumed silica have attracted attention because these abrasive grains are fine particles, and thus a smooth mirror surface can be obtained.

Such a composition for polishing is also referred to as “slurry” and may be described as slurry below. In addition, the terms “polishing” and “mirror polishing” used below are synonymous.

As a composition for polishing (hereinafter also referred to as “polishing composition”) containing silica abrasive grains as a component, a solution containing an alkaline component is generally used. This polishing process utilizes a chemical action of the alkali, which is a component of the polishing composition. More specifically, this polishing process utilizes a corrosion property of the alkali to a workpiece including a silicon oxide film, a metal film, and the like. That is, a thin soft corrosion layer is formed on the surface of a workpiece such as a wafer by means of the corrosiveness of an alkali. The polishing process is performed by removing the thin layer through a mechanical action of fine abrasive grains.

In such a polishing process, the shape of silica particles of colloidal silica or fumed silica is an important factor. As described above, the surface of a workpiece is corroded by an alkali, thus forming a thin layer. The speed of the removal of this thin layer is significantly changed in accordance with the shape of the silica particles. The use of silica particles having a large particle diameter increases the speed of the removal. However, in this case, scratches are easily formed on the polished surface. In addition, the use of particles having an irregular shape increases the speed of the removal, as compared with the use of particles having a spherical shape. However, in this case, scratches are easily formed on the polished surface. Accordingly, the particles must have an appropriate size and an appropriate shape, and must not be easily broken or become highly agglomerated to form a gel. That is, silica particles are used for effectively removing a corrosion layer formed through an action of an alkali by a mechanical action of the silica particles. Accordingly, the silica particles must not affect the new polished surface obtained after the corrosion layer is removed.

Generally commercially available fumed silica is produced by hydrolyzing silicon tetrachloride at a high temperature in an oxyhydrogen flame. About two to seven particles are fused to form a long primary particle, and such primary particles are entangled and agglomerated to form secondary particles. The term “primary particle diameter” (which may be simply written as “particle diameter”) of fumed silica refers to the thickness of the primary particles. The primary particle diameter of fumed silica is generally in the range of 7 to 40 nm, which does not reflect the length in the major axis direction. The term “particle diameter” and the term “average particle diameter” used in patent documents refer to the primary particle diameter in some cases and refer to the secondary particle diameter in some cases. Regarding the particle diameter of fumed silica dispersed in water, the term “particle diameter” and the “average particle diameter” often refer to the secondary particle diameter. The specific surface area measured by the BET method relates to the primary particle diameter. Specifically, particles whose primary particles are thick (i.e., whose primary particles are large) have a small specific surface area.

To date, many proposals concerning fumed silica used as a polishing agent have been made. Claim 1 of Japanese Unexamined Patent Application Publication No. 9-193004 (document '004) discloses a polishing agent composed of a silica dispersion prepared by dispersing fumed silica having an average primary particle diameter in the range of 5 to 50 nm in an aqueous solvent, wherein the light scattering index (n) at a silica concentration of 1.5 weight percent is in the range of 3 to 6, and the average secondary particle diameter of the dispersed fumed silica determined in terms of the weight is in the range of 30 to 100 nm. Claim 4 of document '004 discloses a grinding method using a high-pressure homogenizer. However, the dispersion containing silica having an average secondary particle diameter of 30 nm described in Claim 1 of document '004 cannot be produced by the grinding method using a high-pressure homogenizer. The smallest average secondary particle diameter described in the examples is 52 nm (Example 6), and the average primary particle diameter thereof is 7 nm. This means that agglomerated particles are merely dispersed. The average secondary particle diameters in other examples are also large, and thus the primary particles are not ground in the examples. When a high-pressure homogenizer is used for fine grinding under a severe condition, a diamond member provided at an impact portion is worn out, thus producing a contamination component of the silica dispersion. Furthermore, replacing the diamond member requires a high cost. Therefore, this method is not employed as an industrial grinding method.

In addition, referring to paragraphs 0018 and 0019 of the specification of document '004, the average primary particle diameter of fumed silica is calculated from the specific surface area thereof using formula (I) below:

d=6/(S×D) (1)

wherein d represents the average primary particle diameter (nm), S represents the specific surface area (m²/g), and D represents the density of fumed silica (2.2 g/cm³). However, this is a formula for converting the specific surface area of spherical silica into the particle diameter thereof. Accordingly, even if this formula is used for long fumed silica particles, the calculated particle diameter merely reflects the degree of the thickness of the particles.

Examples 1 to 4 of Japanese Unexamined Patent Application Publication No. 11-57454 disclose a method of dispersing fumed silica, fumed alumina, or fumed titania with a high-pressure homogenizer or a bead mill. However, the average particle diameter thereof is in the range of 120 to 250 nm. Even when bead mill grinding is performed using beads having a diameter of 1 mm, the average particle diameter is 120 nm.

Claim 1 of Japanese Unexamined Patent Application Publication No. 2004-43298 (document '298) discloses a method of producing a silica dispersion in which 5 to 30 weight percent of ground silica particles having an average particle diameter of less than 100 nm is dispersed in a polar solvent, the method including performing a counter collision of a silica slurry prepared by dispersing dry-process silica particles in a polar solvent, thereby grinding the silica particles so as to have an average particle diameter of less than 100 nm. Paragraph 0039 of the specification of document '298 describes the use of a nanomizer having a performance higher than that of a homogenizer.

Examples in document '298 describe that the specific surface area is not changed before and after the grinding. This result shows that the grinding merely functions as a dispersing treatment of agglomerated particles. When dispersed particles are further ground, the specific surface area should be increased by an increase in the cross sections of separated particles. Accordingly, this result shows that primary particles are not ground even when the high-performance nanomizer is used.

Examples 10 and 12 of document '298 describe grounded silica particles having an average particle diameter of less than 30 nm. However, the specific surface areas thereof are 380 m²/g and 205 m²/g, both of which are larger than 200 m²/g, and correspond to an average primary particle diameter of 7 nm and 13 nm, respectively. Accordingly, the particle diameters of these silica particles are too small to be suitable for use in a polishing agent.

Claims 2, 15, 17, and 19 of Japanese Unexamined Patent Application Publication No. 2004-511900 disclose a CMP slurry composition wherein the primary particle diameter of silica grinding particles after jet-grinding has a primary particle diameter in the range of 10 to 50 nm, and an average secondary particle diameter in the range of 220 to 290 nm or 150 to 220 nm. In view of this average secondary particle diameter, secondary agglomerated particles are merely ground, and grinding of primary particles is not performed. Furthermore, according to paragraph 0022 of the specification, the use of a bead grinding method decreases the grinding efficiency and the production efficiency because of, for example, formation of ultrafine particles and polydispersity.

Examples 1 to 3 of Japanese Unexamined Patent Application Publication No. 2005-286046 disclose a method of producing an alkaline dispersion including dispersing fumed silica in an aqueous solution of hydrochloric acid, and then adding an alkali to the dispersion. In this method, dispersion is performed for two to four hours using a high-shear dispersing device as a dispersing device. Even when dispersion is performed under such improved conditions, the average (secondary) particle diameter of the silica of the resulting dispersion is in the range of 87 to 110 nm, which means agglomeration of the particles is merely decreased.

Claims of Japanese Unexamined Patent Application Publication No. 2007-13070 discloses a polishing composition for polishing containing fumed silica participles having a specific surface area in the range of 50 to 200 m²/g measured by the BET method and an average ratio A/B of the major axis A to the minor axis B of the silica particles in the range of 1.2 to 7 measured by transmission electron microscope (TEM) observation. However, this document does not refer to the average secondary particle diameter measured by a laser light-scattering method. According to a recent research made by the present inventors, the average secondary particle diameter after grinding did not significantly differ from that before grinding, and the fumed silica particles formed large secondary particles.

As disclosed in Japanese Unexamined Patent Application Publication Nos. 2005-244123 (Claims), 2005-38924 (Example 3), and 2006-49479 (Claim 4), combination of fumed silica with colloidal silica has been proposed, and advantages have been achieved to some degree. However, commercially available fumed silica is used without further treatment in the techniques described in each of these patent documents. Accordingly, disadvantages of fumed silica have not been fundamentally solved.

Furthermore, comparing the polishing process of the edge portion of a semiconductor wafer with the polishing process of the surface portion of a semiconductor wafer, in the former polishing process, the time during which a polishing pad is in contact with the edge portion is shorter than the time in the latter polishing process. Therefore, in the polishing process of the edge portion, the pressure applied to the surface to be processed is set to be higher than that in the polishing process of the surface portion, and the linear velocity of the polishing pad relative to the surface to be processed is also set to be higher than that in the polishing process of the surface portion. That is, the polishing process of the edge portion is performed under significantly severe conditions as compared with those of the polishing process of the surface portion. The surface roughness of the edge portion of a semiconductor wafer is very large. Accordingly, even if a known composition for polishing a surface of a semiconductor wafer is used under such process conditions, a satisfactory polishing speed and a satisfactory surface roughness cannot be obtained.

### SUMMARY OF THE INVENTION

Accordingly, it is an object of the present invention to provide a composition for polishing used for performing mirror polishing of a surface and the edge portion of a semiconductor wafer in which the polishing speed is high and a satisfactory surface roughness can be obtained. Furthermore, it is another object of the present invention to provide a method of mirror-polishing a semiconductor wafer using the above composition for polishing a semiconductor wafer.

The present inventors have found that mirror polishing of a surface and the edge portion of a semiconductor wafer can be effectively performed by using a composition for polishing a semiconductor wafer, the composition containing a specific fumed silica functioning as abrasive grains, wherein the concentration of silica particles containing the fumed silica is in the range of 0.5 to 50 weight percent relative to the total weight of an aqueous dispersion, and this finding resulted in completion of the present invention. The term “semiconductor wafer” in the present invention refers to, for example, a silicon wafer or a semiconductor device substrate having a metal film, an oxide film, a nitride film, and the like thereon.

Specifically, a first aspect of the present invention provides a composition for polishing a semiconductor wafer containing fumed silica particles that are produced by wet grinding using a grinding medium and that have characteristics (A) to (C):

(A) a specific surface area in the range of 50 to 200 m²/g measured by a BET method;
(B) an average particle diameter in the range of 10 to 50 nm measured by a laser light-scattering method; and
(C) an average ratio A/B of the major axis A to the minor axis B of the fumed silica particles in the range of 1.2 to 2.0 measured by TEM observation,
wherein the concentration of silica particles containing the fumed silica particles is in the range of 0.5 to 50 weight percent relative to the total weight of an aqueous dispersion.

A second aspect of the present invention provides the composition for polishing a semiconductor wafer according to the first aspect of the present invention further containing colloidal silica particles, wherein the concentration of the fumed silica particles is in the range of 0.5 to 10 weight percent relative to the total weight of the aqueous dispersion, and the total concentration of the silica particles is in the range of 0.5 to 50 weight percent relative to the total weight of the aqueous dispersion.

Furthermore, the composition for polishing a semiconductor wafer according to the first aspect or the second aspect of the present invention preferably contains a base (an alkali agent), and the pH of the composition at 25° C. is preferably in the range of 8 to 11.

The composition for polishing a semiconductor wafer preferably contains a buffering solution prepared by combining a weak acid having a logarithm (pKa) of the reciprocal number of acid dissociation constant at 25° C. in the range of 8.0 to 12.5 with a strong base, and the composition preferably has a buffering action at a pH in the range of 8 to 11.

An anion forming the weak acid is preferably a carbonate ion or a hydrogen carbonate ion, and a cation forming the strong base is preferably at least one ion selected from an alkali metal ion, a choline ion, a tetramethylammonium ion, and a quaternary ammonium ion.

The electrical conductivity of the composition for polishing a semiconductor wafer at 25° C. is preferably at least 20 mS/m per weight percent of silica particles.

A third aspect of the present invention provides a method of producing the above composition for polishing a semiconductor wafer including the steps of mixing an aqueous solution of a strong base with fumed silica particles; wet-grinding the mixture; adding a weak acid to the ground mixture to prepare a buffering solution; and wet-grinding the buffering solution.

A fourth aspect of the present invention provides a method of producing the above composition for polishing a semiconductor wafer including the steps of mixing fumed silica particles with an aqueous solution that contains a weak acid and a strong base and that has a buffering action at a pH in the range of 8 to 11; and wet-grinding the mixture. In the third aspect and the fourth aspect of the present invention, the wet grinding using a grinding medium is preferably bead mill grinding using spherical beads having a diameter in the range of 0.02 to 0.2 mm as the grinding medium.

The use of the polishing composition according to the present invention can provide significant advantages in polishing of a semiconductor wafer or the like. According to the present invention, a polishing composition which has an excellent polishing ability lasting for a long time in the mirror polishing of a wafer, which has been unsatisfactory to date, can be provided. Accordingly, the present invention provides a significant advantage to the related industrial field.

### BRIEF DESCRIPTION OF THE DRAWINGS

FIG. 1 is a TEM image of silica particles of Slurry A0 (Comparative Example 1);

FIG. 2 is a TEM image of silica particles of Slurry A1 (Example 1);

FIG. 3 is a graph of the particle size distribution of silica particles of Slurry A0 (Comparative Example 1);

FIG. 4 is a graph of the particle size distribution of silica particles of Slurry A1 (Example 1);

FIG. 5 is a graph of the particle size distribution of silica particles of Example 33;

FIG. 6 is a TEM image of silica particles of Example 33;

FIG. 7 is a graph of the particle size distribution before grinding of Comparative Example 13; and

FIG. 8 is a graph of the particle size distribution after grinding of Comparative Example 13.

### DESCRIPTION OF THE PREFERRED EMBODIMENTS

Fumed silica is generally produced by burning silicon tetrachloride in an oxyhydrogen flame. The resulting fumed silica contains a hydrochloric acid component generated during burning and is acidic. Fumed silica products having a specific surface area in the range of about 50 to 500 m²/g are produced by changing the production conditions. A product prepared by modifying fumed silica particles with aluminum oxide is also available. Examples of commercially available fumed silica products include AEROSIL manufactured by Degussa and CAB-O-SIL manufactured by Cabot Corporation. Aqueous dispersions (slurries) thereof are also commercially available. Dispersions prepared by dispersing any of these commercially available fumed silica products in water without further treatment cannot be used in the present invention.

In the present invention, fumed silica particles having a specific particle diameter and a specific shape are used as polishing abrasive grains contained in a composition for polishing a semiconductor wafer. More specifically, in the present invention, it is important that fumed silica particles used as polishing abrasive grains have a specific surface area in the range of 50 to 200 m²/g measured by the BET method and an average particle diameter in the range of 10 to 50 nm measured by a laser light-scattering method, and the ratio A/B of the major axis A to the minor axis B of each of the fumed silica particles be in the range of 1.2 to 2.0.

As described above, the average primary particle diameter calculated from the specific surface area for a sphere is represented by the following formula:

d=6/(S×D)

When this formula is rearranged, the following relationship is satisfied:

2,720/specific surface area (m²/g)=average primary particle diameter (nm) calculated for a sphere

Accordingly, the phrase “the specific surface area is in the range of 50 to 200 m²/g” may be thought to be equivalent to “the average primary particle diameter is in the range of 13.6 to 54.4 nm”, but this is not accurate. Furthermore, the average primary particle diameter provided by some manufacturers is a value measured by electron microscopy. In such a case, the relationships represented by the above formulae do not apply.

Commercially available fumed silica particles do not have a spherical shape. Various types of primary particles having a shape in which two to seven spherical particles are connected or branched, a rod-like shape, an ovoid shape, a cocoon shape, a string shape, or the like are further agglomerated to form secondary particles, and thus commercially available fumed silica particles have irregular shapes. Therefore, the accurate shape of such fumed silica particles cannot be satisfactorily represented by a numerical value including the average primary particle diameter calculated for a sphere. Accordingly, the specific surface area is used in the present invention from the standpoint that the thickness of the particles is represented.

In the present invention, the average particle diameter measured by a laser light-scattering method is in the range of 10 to 50 nm. The average particle diameter of the present invention measured by a laser light-scattering method is determined as follows. For a laser beam that is reflected by particles and backscattered, the frequency modulation of scattered light due to the laser Doppler effect and the intensity thereof are measured, and the particle size distribution is determined by frequency analysis. The measured value is a value of 50% of the cumulative frequency in the distribution in terms of volume (this value generally being referred to as “50% diameter” and often being represented by “R50”). This 50% diameter is generally used as a parameter for evaluating the particle size distribution as a “cumulative average diameter (median diameter)”. A “Microtrac UPA 150” particle analyzer manufactured by Nikkiso Co., Ltd. was used. This analyzer is widely used for measuring the particle size distribution of colloidal fine particles and described in many specifications for patent applications. If the average particle diameter is less than 10 nm, the polishing speed is too low, and such silica particles are not suitable for practical use. If the average particle diameter is more than 50 nm, defects such as scratches are easily formed. The average particle diameter is more preferably in the range of 20 to 40 nm.

Furthermore, by limiting the ratio A/B of the major axis A to the minor axis B of each of the particles to be in the range of 1.2 to 2.0, the shape of fumed silica particles used in the present invention can be accurately represented, and this feature shows that the fumed silica used in the present invention is different from generally known fumed silica products. This fumed silica has, for example, a shape in which, among generally known fumed silica products, thick string-shaped particles are cut so as to have a smaller length. More specifically, when the specific surface area is 100 m²/g and the ratio A/B is 2, the particle has an ovoid shape having a minor axis of about 25 nm and a major axis of about 50 nm. When the specific surface area is 200 m²/g and the ratio A/B is 1.2, the particle has a distorted spherical shape or a distorted cubic shape having a minor axis of about 13 nm and a major axis of about 15 nm.

Such fumed silica particles can be prepared by grinding a known fumed silica product by a wet process using a strong grinding device such as a bead mill or a sand grinder, and then removing coarse particles from the resulting slurry by sedimentation (water elutriation). Furthermore, a wet grinding using a bead mill is preferable. A bead mill grinding using zirconia beads having a diameter in the range of 0.02 to 0.2 mm as a grinding medium is more preferable. If the diameter of the beads is less than 0.02 mm, the beads cannot be separated from ground silica particles. If the diameter of the beads is more than 0.2 mm, the grinding ability is insufficient, and thus, a slurry in which coarse particles are mixed and which contains particles having a wide particle size distribution is produced. Beads having a diameter in the range of 0.05 to 0.1 mm are most preferably used. In this case, ground silica particles having a narrow particle size distribution can be obtained by allowing the particles to pass through the bead mill only once, and an additional step, such as a step of removing coarse particles, need not be performed.

The above-described fumed silica particles can be dispersed in water to prepare a stable colloidal dispersion. Fumed silica particles having a specific surface area of less than 50 m²/g are not easily produced in the stage of the raw material thereof, and it is difficult to obtain such fumed silica particles. Regarding fumed silica particles having a specific surface area of more than 200 m²/g, physical properties of such particles are easily changed, for example, secondary agglomeration occurs during use. Accordingly, the polishing performance cannot be stabilized in using such fumed silica particles. On the basis of the same reasons as those described above, more preferable specific surface area is in the range of 100 to 200 m²/g. Fumed silica particles having a ratio A/B of less than 1.2 cannot achieve the objects of the present invention because of a low polishing ability of the particles. On the other hand, fumed silica particles having a ratio A/B of more than 2.0 have a high polishing ability, but easily form defects of scratches on the polished surface. Accordingly, it is difficult to obtain a smooth surface profile. In addition, physical properties of such fumed silica particles easily change, for example, secondary agglomeration occurs during use. Accordingly, the polishing performance cannot be stabilized in using such fumed silica particles. From the standpoint of an improvement in the polishing ability and the stability of the polishing composition, the ratio A/B is preferably in the range of 1.2 to 2.0. This fumed silica is preferably contained in an amount of 3 weight percent or more relative to the total weight of silica particles in the solution. In the present invention, silica particles other than the above-described fumed silica particles may be contained in the polishing composition. As described above, combination with colloidal silica is particularly preferred. Examples of the other silica particles include polishing particles that are generally used for polishing a semiconductor wafer, such as fumed silica particles that do not satisfy the above specific values, and colloidal silica particles having, for example, a string shape, a cocoon shape, or a flat spherical shape, all of which are not spherical.

In the polishing composition of the present invention, the concentration of silica particles containing the fumed silica is preferably in the range of 0.5 to 50 weight percent relative to the total weight of the solution. The concentration is appropriately selected in accordance with the type of workpiece to be polished, such as a metal or silicon oxide, and cannot be generally limited. For example, a copper alloy film can be polished using a polishing composition containing silica particles in an amount in the range of 0.5 to 2 weight percent. In contrast, in polishing an edge portion, the concentration of silica particles is preferably in the range of 2 to 25 weight percent from the standpoint that the polishing ability of the polishing composition is further improved. In general, preferably, a slurry having a high concentration of silica particles of 30 weight percent or more is prepared in advance, and the slurry is appropriately diluted when being used. In a step of polishing a plurality of wafers while a slurry is circulated, purified water is easily mixed with the slurry, thereby diluting the slurry. In order to recover the concentration of the diluted slurry, a slurry having a high concentration is prepared in advance, and the slurry is preferably added during the step. In addition, the polishing composition preferably contains a base (an alkali agent) and the pH of the polishing composition is preferably in the range of 8 to 11 at 25° C.

Furthermore, in the present invention, in order to maintain a stable polishing ability during the polishing process, preferably, the pH of the solution is maintained in the range of 8 to 11. If the pH of the solution is less than 8, the polishing speed decreases, and the polishing composition may not be practically used. On the other hand, if the pH of the solution exceeds 11, areas other than the polished portion are excessively etched, and the silica particles start to agglomerate, thereby degrading the stability of the polishing composition. Such a polishing composition may not also be practically used. Furthermore, preferably, this pH is not easily changed by possible external conditions such as friction, heat, contact with outside air, and mixing with other components. In particular, in an edge polishing, the polishing composition is used as a circulating flow. More specifically, a polishing composition is used in a manner in which the polishing composition supplied from a slurry tank to a polishing portion is returned to the slurry tank. The pH of polishing compositions containing only an alkali agent in the related art decreases during use within a short period of time. This decrease in the pH is caused by the dissolution of polished matters and mixing of wash water. In such a case, maintaining the pH of the polishing composition in the slurry tank to be constant is a very troublesome operation, and, for example, insufficiently polished products tend to be produced.

Accordingly, in the present invention, the polishing composition itself is preferably a liquid having a strong buffering action. That is, a change in the pH of the polishing composition due to a change in external conditions is preferably small. In order to prepare a buffering solution, a weak acid having a logarithm (pKa) of the reciprocal number of acid dissociation constant (Ka) at 25° C. in the range of 8.0 to 12.5 and a strong base are used in combination. A logarithm (pKa) of the reciprocal number of acid dissociation constant at 25° C. of less than 8.0 is not preferable because it is necessary to add large amounts of a weak acid and a strong base in order to increase the pH. A logarithm (pKa) of the reciprocal number of acid dissociation constant at 25° C. of more than 12.5 is not preferable because it is difficult to prepare a buffering solution having a strong buffering action for maintaining the pH to be in the range of 8 to 11.

In the present invention, examples of the weak acid used for preparing a solution of a polishing composition having a buffering action include inorganic acids such as carbonic acid (pKa=6.35 and 10.33), boric acid (pKa=9.24), and phosphoric acid (pKa=2.15, 7.20, and 12.35); and water-soluble organic acids; and mixtures thereof. Specific examples of the water-soluble organic acid include phenols such as phenol (pKa=10.0), catechol (pKa=9.25 and 12.37), and hydroquinone (pKa=9.91 and 11.56); amines such as ethylenediamine (pKa=7.52<10.65) and 2-aminoethanol (pKa=9.5); amino acids such as glycine (pKa=2.35 and 9.78) and 4-aminobutyric acid (pKa=4.03 and 10.56); and heterocyclic compounds such as pyrrolidine (pKa=11.3) and piperidine (pKa=11.12). Carbonic acid includes the form of a hydrogen carbonate ion. Regarding the strong base, a cation forming the strong base is preferably at least one ion selected from an alkali metal ion, a choline ion, a tetramethylammonium ion, and a quaternary ammonium ion.

As quaternary ammonium ions other than a choline ion and a tetramethylammonium ion, a tetraethylammonium ion, a benzyltrimethylammonium ion, a tetrapropylammonium ion, a tetrabutylammonium ion, a phenyltrimethylammonium ion, and a methyltrihydroxyethylammonium ion are preferred in view of availability.

The buffering solution described in the present invention refers to a solution which is prepared by combining the weak acid and the strong base described above and in which the weak acid is dissociated as ions having a different number of valences in the solution or in which a dissociated state and a non-dissociated state of the weak acid coexist in the solution. The buffering solution described in the present invention is characterized in that the pH of the solution is hardly changed even when a small amount of an acid or a base is mixed therewith.

In the present invention, the polishing speed can be markedly increased by increasing the electrical conductivity of the solution of a polishing composition. The electrical conductivity is a numerical value indicating the ease with which an electric current is conducted in a liquid, and is represented by the reciprocal number of electrical resistance per unit length. In the present invention, the electrical conductivity is represented by a numerical value obtained by converting electrical conductivity (micro·Siemens) per unit length into a value per weight percent of silica. In the present invention, from the standpoint of an improvement in the polishing speed, the electrical conductivity at 25° C. is preferably 20 mS/m/1%-SiO₂ or more, and more preferably 25 mS/m/1%-SiO₂ or more. In order to increase the electrical conductivity, the following two methods are employed. A first method is a method of increasing the concentration of the buffering solution, and a second method is a method of adding a salt to the buffering solution. In order to increase the concentration of the buffering solution, only the concentration is increased without changing the molar ratio of the acid to the base. The salt used in the second method of adding a salt is determined by a combination of an acid and a base. Either a strong acid or a weak acid may be used for the acid. Examples thereof include mineral acids, organic acids, and mixtures thereof. Either a strong base or a weak base may be used for the base. Examples thereof include hydroxides of an alkali metal, hydroxides of a water-soluble quaternary ammonium, water-soluble amines, and ammonia, and mixtures thereof. When a weak acid and a strong base, a strong acid and a weak base, or a weak acid and a weak base are added in combination, adding a large amount of the acid and the base is not preferable because the pH of the buffering solution may be changed. The first method and the second method may be used in combination.

The composition for polishing a semiconductor wafer of the present invention may contain other silica particles as long as the composition is an aqueous dispersion containing, as silica particles, fumed silica particles having a specific surface area in the range of 50 to 200 m²/g measured by the BET method, an average particle diameter in the range of 10 to 50 nm measured by a laser light-scattering method, and an average ratio A/B of the major axis A to the minor axis B of the silica particles in the range of 1.2 to 2.0 measured by TEM observation in an amount of 10 weight percent or more, and the concentration of the silica particles relative to the total weight of the solution is in the range of 0.5 to 50 weight percent. Examples of the other silica particles include polishing particles that are generally used for polishing a semiconductor wafer, such as fumed silica particles that do not satisfy the above specific values and colloidal silica particles. Among these, colloidal silica particles are particularly preferred.

The silica weight of colloidal silica mixed can be in the range of 1 to 10 parts by weight relative to 1 part by weight of silica of the fumed silica. Preferably, the silica weight of colloidal silica mixed is in the range of 2 to 8 parts by weight.

In addition, containing polishing abrasive grains other than silica is also preferred. Preferable examples of the polishing abrasive grains other than silica include ceria, alumina, zirconia, organic abrasive grains, and silica-organic composite abrasive grains. The abrasive grains made of ceria, alumina, or zirconia preferably have a particle diameter in the range of 20 to 100 nm.

The polishing composition of the present invention preferably contains a chelating agent. Examples of the chelating agent include dicarboxylic acids such as oxalic acid, malonic acid, and succinic acid; polycarboxylic acids such as tricarballylic acid; hydroxycarboxylic acids such as citric acid and malic acid; and aminopolycarboxylic acids such as nitrilotriacetic acid and ethylenediaminetetraacetic acid. Any chelating agents that are bonded as a multidentate ligand of a metal can be used as long as the chelating agents do not impair the advantages of the present invention.

More specifically, the chelating agent is preferably selected from (1) ethylenediaminetetraacetates, (2) hydroxyethylethylenediaminetriacetates, (3) dihydroxyethylethylenediaminediacetates, (4) diethylenetriaminepentaacetates, (5) triethylenetetraminehexaacetates, (6) hydroxyethyliminodiacetates, and (7) gluconates. Specific examples thereof include (1) disodium ethylenediaminetetraacetate, trisodium ethylenediaminetetraacetate, tetrasodium ethylenediaminetetraacetate, diammonium ethylenediaminetetraacetate, triammonium ethylenediaminetetraacetate, and tetraammonium ethylenediaminetetraacetate; (2) trisodium hydroxyethylethylenediamine triacetate and triammonium hydroxyethylethylenediamine triacetate; (3) disodium dihydroxyethylethylenediaminediacetate and diammonium dihydroxyethylethylenediaminediacetate; (4) pentasodium diethylenetriaminepentaacetate, pentaammonium diethylenetriaminepentaacetate, iron-disodium diethylenetriaminepentaacetate, and iron-diammonium diethylenetriaminepentaacetate; (5) hexasodium triethylenetetraminehexaacetate and hexaammonium triethylenetetraminehexaacetate; (6) disodium hydroxyethyliminodiacetate and diammonium hydroxyethyliminodiacetate; and (7) sodium gluconate, potassium gluconate, calcium gluconate, and gluconate-6-phosphate trisodium salt.

Among these chelating agents, acid-type chelating agents and ammonium-salt-type chelating agents, all of which contain no alkali metal, are preferably used. These chelating agents may contain water of crystallization or may be anhydrides. These chelating agents may be used in combinations of two or more compounds. In such a case, the chelating agents may be combined in any ratio.

Furthermore, the polishing composition preferably contains a chelating agent that forms a water-insoluble chelate compound with copper. Examples of preferred chelating agents include known compounds such as azoles, e.g., benzotriazole; and quinoline derivatives, e.g., quinolinol and quinaldic acid.

The content of a chelating agent of the polishing composition of the present invention is different depending on the effect of chelating agent used, but preferably in the range of 0.01 to 1 weight percent, and more preferably in the range of 0.05 to 0.5 weight percent relative to the total weight of the polishing composition. In general, by increasing the amount of chelating agent added, the effect of the present invention tends to more significantly exhibit. However, attention should be paid because addition of an excessive amount of a chelating agent degrades the advantages of the present invention and may cause an economical disadvantage.

Furthermore, the polishing composition of the present invention preferably contains a surfactant. Examples of the surfactant that can be used include anionic surfactants, cationic surfactants, nonionic surfactants, amphoteric surfactants, and polymer surfactants. In particular, the polishing composition of the present invention preferably contains a nonionic surfactant. Nonionic surfactants have an effect of preventing excessive etching. Examples of the nonionic surfactant include polyoxyalkylene alkyl ethers such as polyoxyethylene lauryl ether; fatty acid esters such as glycerol esters; and polyoxyalkylene alkylamines such as di polyoxyethylene laurylamine. Among these, polyoxyalkylene alkylethers are particularly preferred. The concentration of the surfactant in the polishing composition is preferably in the range of about 1 to 1,000 ppm.

The use of surfactants, particularly anionic surfactants, easily causes a negative phenomenon of foaming in some cases. To suppress this foaming, an antifoaming agent is generally used in combination. A silicone antifoaming agent is significantly effective. Examples of silicone antifoaming agents include oil-type silicone antifoaming agents, modified-oil-type silicone antifoaming agents, solution-type silicone antifoaming agents, powder-type silicone antifoaming agents, and emulsion-type silicone antifoaming agents. Among these, modified-oil-type silicone antifoaming agents and emulsion-type silicone antifoaming agents can be used because they are satisfactorily dispersed in a colloidal solution. In particular, emulsion-type silicone antifoaming agents are most effective and have a satisfactory continuity of the effect. Examples of commercially available silicone antifoaming agents include Shin-Etsu silicone KM grade manufactured by Shin-Etsu Chemical Co., Ltd. The amount of antifoaming agent used is appropriately determined in accordance with the amount of surfactant used. The amount of antifoaming agent used is preferably in the range of about 1 to 1,000 ppm in terms of an antifoaming active ingredient in the polishing composition.

Furthermore, in the present invention, the advantages of the present invention can be increased by adding a water-soluble polymer. It is known that a water-soluble polymer having a molecular weight of 5,000 or more and a water-soluble polymer having a molecular weight of 100,000 or more have functions of decreasing metal contaminations of a wafer and improving the flatness of the wafer. However, the use of such a polymer having a high molecular weight is disadvantageous in that only a small amount of the polymer is added so as not to excessively increase the viscosity of the polishing solution. A water-soluble polymer having an average molecular weight of 5,000 or less, and preferably in the range of 500 to 3,000 is preferably added to the polishing composition in an amount in the range of about 100 to 10,000 ppm.

Examples of the water-soluble polymer that can be used include polyacrylic acid, polymethacrylic acid, polyvinylpyrrolidone, polyvinyl alcohol, polyethylene glycol, maleic acid-vinyl copolymers, xanthan gum, and cellulose derivatives. The water-soluble polymer is preferably at least one polymer selected from cellulose derivatives, polyvinyl alcohol, and polyethylene glycol. Examples of the cellulose derivatives include hydroxymethylcellulose, hydroxyethylcellulose, hydroxypropylcellulose, and carboxymethylcellulose. Among these, hydroxyethylcellulose is preferred. Polyethylene glycol having a molecular weight of 5,000 or less is further preferred.

In the present invention, an oxidizing agent may be optionally added. Preferable examples of the oxidizing agent include aqueous hydrogen peroxide, persulfates, and perborates.

In order to improve physical properties of the polishing composition of the present invention, a microbicide, an anti-mold agent, a pH indicator, a humectant, a water-miscible organic solvent, an antifreezing agent, an antirust agent, a polishing-end-point-detecting agent, a coloring agent, a sedimentation-preventing agent, and other additives may be used in combination. Specific examples of a dispersing agent and a sedimentation-preventing agent include water-soluble organic substances and inorganic layered compounds. The polishing composition of the present invention is an aqueous solution, but an organic solvent may be added thereto. In particular, ethylene glycol and glycerol are preferably added as an antifreezing agent or a humectant. For example, isopropyl alcohol has a significant effect of decreasing the surface tension. The polishing composition of the present invention may be prepared by mixing another polishing agent such as colloidal silica, a base, additives, water, and the like at the time of polishing.

The method of producing the polishing composition of the present invention is not particularly limited. The polishing composition of the present invention can be produced by, for example, the following method.

Fumed silica particles are mixed with an aqueous solution of a strong base, and wet grinding is performed to disperse the fumed silica particles. A weak acid is then added to the mixture to prepare a buffering solution, and wet grinding is further performed. The wet grinding is performed using a strong grinding device such as a bead mill or a sand grinder. Furthermore, preferably, coarse particles are removed from the resulting slurry by sedimentation. A weak acid, a strong base, deionized water, a salt for adjusting the electrical conductivity, and the like are added to the fumed silica slurry, as needed, thus allowing a polishing composition of the present invention to be prepared.

Alternatively, an aqueous solution containing a weak acid and a strong base and having a buffering action at a pH in the range of 8 to 11 may be prepared in advance. Fumed silica particles are mixed with this buffering solution, and wet grinding of the resulting mixture is performed. Various additives the same as those described above are then added to the resulting fumed silica slurry, thus allowing a polishing composition to be prepared.

In both methods, it is important that a basic aqueous solution be mixed with fumed silica particles, and acidic or neutral water is not used.

Next, polishing methods using the polishing composition of the present invention will now be described.

A surface polishing is performed as follows. A surface of a workpiece to be polished is pressed onto a rotatable surface plate in which a polishing cloth made of a synthetic resin foam, a suede-like synthetic leather, or the like is applied on at least one of the top surface and the bottom surface of the surface plate. The surface of the workpiece is polished by rotating at least one of the surface plate and the workpiece while the polishing composition of the present invention and the like is quantitatively supplied. Examples of a machine for surface polishing used in the present invention include an SH-24 single-side polisher and a FAM-20B double-side polisher, both of which are manufactured by SpeedFam Co., Ltd.

An edge polishing is generally performed using a polishing machine in which a polishing pad made of a synthetic resin foam, a synthetic leather, a nonwoven fabric, or the like is applied on the surface of a rotatable pad support. An edge portion of, for example, a silicon wafer, which is a work (workpiece), obtained after beveling is pressed onto the pad support in an oblique manner while the edge portion is rotated. The edge portion is polished while a solution of the polishing composition of the present invention is supplied. An example of a machine for edge polishing used in the present invention is an EP-2001V edge polisher manufactured by SpeedFam Co., Ltd. The edge polisher includes a rotatable pad support in which a polishing pad is applied on the surface thereof and a holder that holds and rotates a work and inclines the work at any angle. The edge portion of the work attached to the holder is pressed onto the pad support, and both the work and the pad support are rotated while the polishing composition of the present invention is supplied. Thus, the edge portion of the work is mirror-polished. More specifically, the work is pressed onto the pad support, which gradually moves upward or downward while being rotated, at a predetermined angle while the work is rotated. Thus, the edge portion is polished while the polishing composition of the present invention is added dropwise onto the portion to be processed. A specific method of polishing a semiconductor wafer using the polishing composition of the present invention will be described in detail using the examples below. The polishing machines are not limited to the above-mentioned polishers. Other polishing machines described in, for example, Japanese Unexamined Patent Application Publication Nos. 2000-317788 and 2002-36079 can also be used.

### EXAMPLES

Compositions for polishing a semiconductor wafer of the present invention and methods of polishing using the polishing compositions will now be described specifically using examples and comparative examples, but the present invention is not limited to these examples.

The following apparatuses were used in the measurements in the examples.

Specific surface area measured by the BET method: Flow Sorb 2300 manufactured by Shimadzu Corporation

TEM observation: Transmission electron microscope H-7500 manufactured by Hitachi, Ltd.

Average particle diameter measured by a laser light-scattering method: Microtrac UPA 150 manufactured by Nikkiso Co., Ltd.

The following chemicals were used in the examples.

Tetramethylammonium hydroxide: a commercially available 25% aqueous solution of TMAOH

Tetramethylammonium hydrogencarbonate: Tetramethylammonium hydrogencarbonate was prepared by injecting carbon dioxide into the above 25% aqueous solution of TMAOH, and neutralizing the solution so as to have a pH of 8.4. According to a chemical analysis result, the prepared solution was a 33% aqueous solution of tetramethylammonium hydrogencarbonate (hereinafter, may be abbreviated as TMAHCO₃).

Potassium fluoride: Analytical grade potassium fluoride (KF) was used.

### <Preparation of Polishing Compositions>

### Comparative Example 1 and Example 1

Preparation of Slurry A: Tetramethylammonium Hydroxide was added to 75 parts by weight of purified water in an amount of 0.15 mol relative to 1 kg of silica, and mixing was performed under stirring. Subsequently, 25 parts by weight of commercially available fumed silica particles (specific surface area measured by the BET method (hereinafter also referred to as “BET specific surface area”): 90 m²/g) were added to the mixture and dispersed by agitation. Thus, a slurry containing 25 weight percent of silica was prepared. This slurry is referred to as Slurry A0 (Comparative Example 1). The pH of Slurry A0 was 10.23, and the BET specific surface area of the silica particles in the slurry was 95 m²/g. The average ratio A/B of the major axis A to the minor axis B of the silica particles measured by TEM observation was 5. The average particle diameter measured by the laser light-scattering method was 266 nm.

Subsequently, this slurry was ground with a bead mill (LMZ 2: manufactured by Ashizawa Finetech Ltd.) using zirconia beads having a diameter of 0.1 mm as a grinding medium at a slurry flow rate of 150 mL/min and at 2,000 rpm. This ground slurry is referred to as Slurry A1 (Example 1).

The pH of Slurry A1 was 9.06, and the BET specific surface area of the silica particles in the slurry was 129 m²/g. The major axis A of the particles measured by TEM observation was 53.6 nm, and the minor axis B thereof was 35.4 nm. The average ratio A/B was 1.51. The average particle diameter measured by the laser light-scattering method was 23.2 nm.

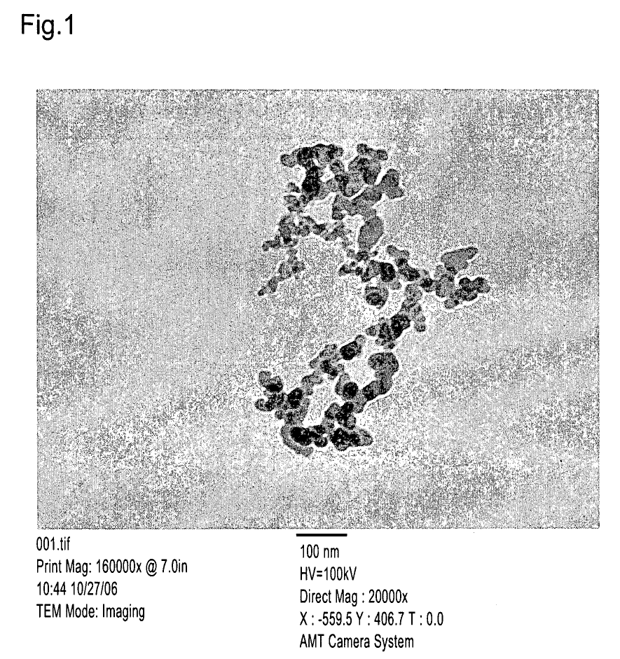

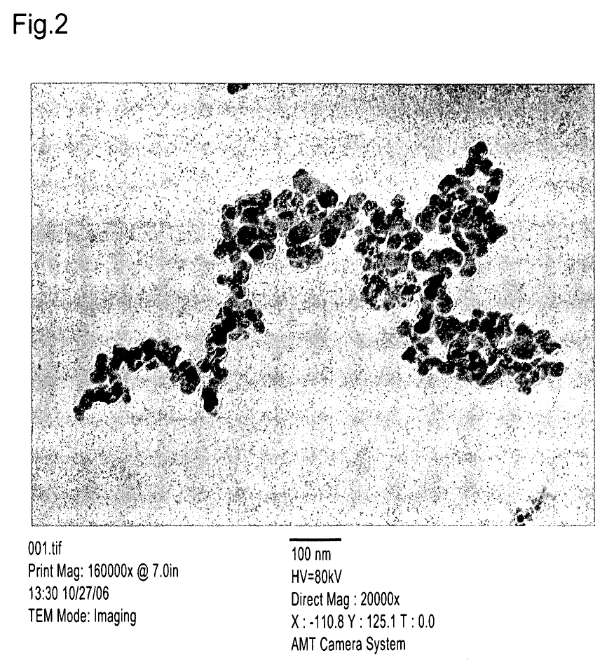

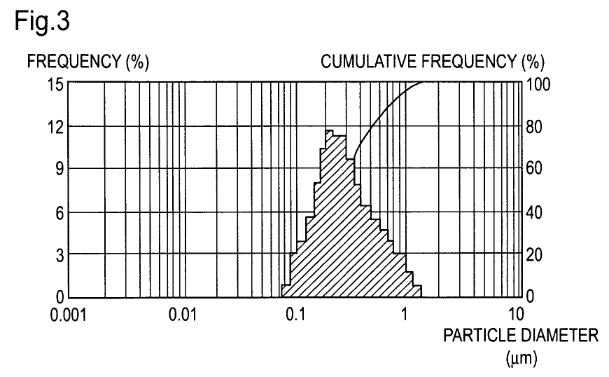

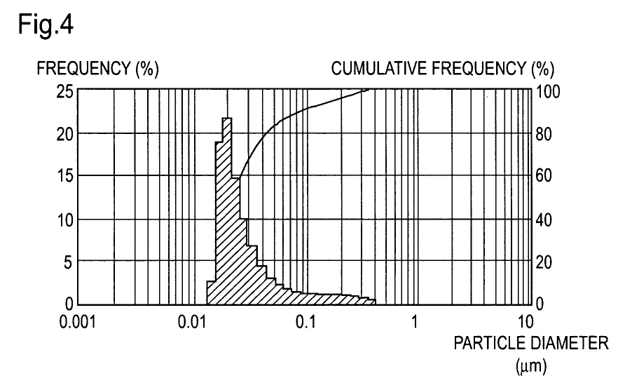

As described above, although the change in the BET specific surface area due to the grinding was not significant, the ratio A/B of the major axis A to the minor axis B of the silica particles was markedly decreased. This result showed that the shape of the particles was changed to a cubic shape by the grinding. The average particle diameter measured by the laser light-scattering method also reflected this state, and showed that not only secondary agglomeration was undone but also grinding of primary particles occurred. FIG. 1 shows a TEM image of silica particles of Slurry A0, and FIG. 2 is a TEM image of silica particles of Slurry A1. FIG. 3 shows the particle size distribution of the silica particles of Slurry A0, and FIG. 4 shows the particle size distribution of the silica particles of Slurry A1.

### Comparative Example 2 and Example 2

Preparation of Slurry B: Tetramethylammonium Hydroxide was added to 80 parts by weight of purified water in an amount of 0.20 mol relative to 1 kg of silica, and mixing was performed under stirring. Subsequently, 20 parts by weight of commercially available fumed silica particles (BET specific surface area: 140 m²/g) were added to the mixture and dispersed by agitation. Thus, a slurry containing 20 weight percent of silica was prepared. This slurry is referred to as Slurry B0 (Comparative Example 2). The pH of Slurry B0 was 9.65, and the BET specific surface area of the silica particles in the slurry was 143 m²/g. The average ratio A/B of the major axis A to the minor axis B of the silica particles measured by TEM observation was 7. The average particle diameter measured by the laser light-scattering method was 353 nm.

Subsequently, this slurry was ground with a bead mill (LMZ 2: manufactured by Ashizawa Finetech Ltd.) using zirconia beads having a diameter of 0.1 mm as a grinding medium at a slurry flow rate of 150 mL/min and at 2,000 rpm. This ground slurry is referred to as Slurry B1 (Example 2).

The pH of Slurry B1 was 9.04 and the BET specific surface area of the silica particles in the slurry was 170 m²/g. The major axis A of the particles measured by TEM observation was 35.5 nm, and the minor axis B thereof was 20.3 nm. The average ratio A/B was 1.75. The average particle diameter measured by the laser light-scattering method was 38.7 nm.

As described above, although the change in the BET specific surface area due to the grinding was not significant, the ratio A/B of the major axis A to the minor axis B of the silica particles was markedly decreased. This result showed that the shape of the particles was changed to a cubic shape by the grinding. The average particle diameter measured by the laser light-scattering method also reflected this state, and showed that not only secondary agglomeration was undone but also grinding of primary particles occurred.

### Examples 3 to 7

Preparation of Slurry C: Slurry A1 was Mixed with commercially available colloidal silica particles (Silicadol, silica concentration: 40 weight percent, manufactured by Nippon Chemical Industrial Co., Ltd.) having a particle diameter of 50 nm and purified water at mixing ratios shown in Table 1, thus allowing Slurry C1 to Slurry C5 (Examples 3 to 7) to be prepared.

Table 2 summarizes physical properties of each of the slurries prepared as described above.

TABLE 1

| | | Colloidal | Purified | |
|---|---|---|---|---|
| | A1 | sillica | water | Silica |
| | Parts by | Parts by | Parts by | concentration |
| Slurry C | weight | weight | weight | wt % |
| C1 | 1 | 1.25 | 0.75 | 25 |
| C2 | 1 | 1.50 | 0.90 | 25 |
| C3 | 1 | 2.00 | 1.20 | 25 |
| C4 | 1 | 3.00 | 1.80 | 25 |
| C5 | 1 | 5.00 | 3.00 | 25 |

TABLE 2

| | | | | | Average |
|---|---|---|---|---|---|
| | Silica | | BET specific | | particle |
| | concentration | | surface area | | diameter |
| Slurry | wt % | pH | m²/g | A/B | nm |
| A0 | 25 | 10.23 | 95 | 5 | 266 |
| A1 | 25 | 9.06 | 129 | 1.5 | 23.2 |
| B0 | 20 | 9.65 | 143 | 5 | 35.3 |
| B1 | 20 | 9.04 | 170 | 1.5 | 38.7 |

| | | |
|---|---|---|
| C1 | 25 | 10.1 |
| C2 | 25 | 10.0 |
| C3 | 25 | 9.9 |
| C4 | 25 | 9.8 |
| C5 | 25 | 9.8 |

Each of the silica slurries was diluted with purified water to a predetermined silica concentration. Chemicals shown in Tables 3 and 4 were then added to the diluted slurries in predetermined amounts. The resulting slurries were used as polishing compositions. Note that the amount of tetramethylammonium hydroxide used in the above grinding process is not included in the amount of chemicals shown in the tables.

Among the additives, tetramethylammonium hydrogencarbonate and potassium hydrogencarbonate are salts forming a combination of carbonic acid (pKa=10.33), which serves as a weak acid, and a strong base, thus forming a buffering solution of the present invention. Potassium fluoride is an additive for increasing the electrical conductivity.

Polishing tests of a semiconductor wafer were performed by the above-described method. In the polishing tests, 8-inch silicon wafers on which a silicon oxide film, a titanium nitride film, and a metal copper film were laminated were used.

### <Edge Polishing Test>

### Examples 8 to 22 and Comparative Examples 3 to 7

Mirror polishing tests of the edge portion of semiconductor wafers were performed using polishing compositions of Examples 8 to 22 and Comparative Examples 3 to 7 shown in Tables 3 and 4 while the polishing compositions were repeatedly circulated.

A machine for polishing a semiconductor wafer edge used in these tests and polishing conditions therefor are as follows:

Polishing machine: EP-2001V edge polisher, manufactured by SpeedFam Co., Ltd.

Rotational speed of drum: 800 RPM

Rotational speed of wafer: 60 sec/REV

The number of rotations of wafer: 4 times/wafer

Polishing cloth: DRP-II (manufactured by SpeedFam Co., Ltd.)

Load: 2.5 kg

Flow rate of polishing composition: 250 mL/min

After the completion of the polishing, purified water was supplied on the wafer instead of the polishing composition to wash the polishing composition. The wafer was then detached from the polishing machine and underwent brush scrub washing using 1% aqueous ammonia and purified water. Spin drying of the wafer was then performed with nitrogen blowing.

The pH of the polishing composition was measured with a pH meter. The electrical conductivity thereof was measured with an electrical conductivity meter. The polishing speed was calculated from the difference between the silicon wafer weight before polishing and the silicon wafer weight after polishing. The polished surface was evaluated as follows. The state of hazing and pits was visually observed under a light-collecting lamp. Insufficiently polished portions due to incomplete edge polishing were observed over the entire circumference of the wafer after polishing using an optical microscope at a magnification of 800.

In all the polishing tests performed using the polishing compositions of Examples 8 to 22 and Comparative Examples 3 to 7, neither hazing nor pits were observed. Other evaluation results are also shown in Tables 3 and 4. Abbreviations used in the tables denote the following. TMAOH: tetramethylammonium hydroxide, KHCO₃: potassium hydrogencarbonate, TMAHCO₃: tetramethylammonium hydrogencarbonate, and KF: potassium fluoride. In the tables, the amounts of these compounds added are represented by the number of moles relative to 1 kg of silica in the polishing composition (mol/kg-SiO₂). The units of the electrical conductivity represent the electrical conductivity relative to 1 weight percent of silica particles (mS/m/1%-SiO₂).

TABLE 3

| | Example | | | | | | | | | |
|---|---|---|---|---|---|---|---|---|---|---|
| | 8 | 9 | 10 | 11 | 12 | 13 | 14 | 15 | 16 | 17 |
| Slurry | A1 | A1 | A1 | A1 | A1 | A1 | B1 | B1 | B1 | B1 |
| Silica | 5 | 10 | 15 | 20 | 25 | 25 | 5 | 10 | 15 | 20 |
| concentration(wt %) | | | | | | | | | | |
| TMAOH(mol/kg- | 0.08 | 0.08 | 0.08 | 0.08 | 0.1 | — | 0.08 | 0.08 | 0.08 | 0.08 |
| SiO2) | | | | | | | | | | |
| TMAHCO3(mol/kg- | | 0.088 | — | 0.088 | 0.11 | — | — | — | — | — |
| SiO2) | | | | | | | | | | |
| KHCO3(mol/kg- | 0.09 | — | 0.088 | — | — | — | 0.09 | 0.09 | 0.088 | 0.09 |
| SiO2) | | | | | | | | | | |
| KF(mol/kg-SiO2) | 0.1 | 0.05 | 0.034 | 0.026 | — | — | 0.1 | 0.05 | 0.034 | 0.03 |
| pH | 10.5 | 10.4 | 10.3 | 10.3 | 10.3 | 9.1 | 10.4 | 10.4 | 10.3 | 10.3 |
| Electrical | 27 | 22 | 20 | 20 | 21 | 0.9 | 27 | 22 | 20 | 20 |
| conductivity(per | | | | | | | | | | |
| weight percent of | | | | | | | | | | |
| silica particles) | | | | | | | | | | |

Results of polishing test
The number of times of circulation: 1

| | | | | | | | | | | |
|---|---|---|---|---|---|---|---|---|---|---|
| Polishing | 2.8 | 3.3 | 3.7 | 4.0 | 4.2 | 3.5 | 2.5 | 3.1 | 3.5 | 3.7 |
| speed(mg/min) | | | | | | | | | | |
| pH | 10.5 | 10.4 | 10.3 | 10.3 | 10.3 | 9.0 | 10.4 | 10.4 | 10.3 | 10.3 |
| Surface state | Good | Good | Good | Good | Good | Good | Good | Good | Good | Good |

The number of times of circulation: 10

| | | | | | | | | | | |
|---|---|---|---|---|---|---|---|---|---|---|
| Polishing | 2.5 | 2.8 | 3.3 | 3.8 | 4.0 | 2.9 | 2.2 | 2.7 | 3.3 | 3.4 |
| speed(mg/min) | | | | | | | | | | |
| pH | 10 | 10 | 10.1 | 10.1 | 10.2 | 8.6 | 10.0 | 10.0 | 10.1 | 10.1 |
| Surface state | Good | Good | Good | Good | Good | Good | Good | Good | Good | Good |

| | Example | | | | |
|---|---|---|---|---|---|
| | 18 | 19 | 20 | 21 | 22 |
| Slurry | C1 | C2 | C3 | C4 | C5 |
| Silica | 20 | 20 | 20 | 20 | 20 |
| concentration(wt %) | | | | | |
| TMAOH(mol/kg- | 0.08 | 0.08 | 0.08 | 0.08 | 0.08 |
| SiO2) | | | | | |
| TMAHCO3(mol/kg- | — | — | — | — | — |
| SiO2) | | | | | |
| KHCO3(mol/kg- | 0.09 | 0.088 | 0.088 | 0.088 | 0.09 |
| SiO2) | | | | | |
| KF(mol/kg-SiO2) | 0.03 | 0.026 | 0.026 | 0.026 | 0.03 |
| pH | 10.3 | 10.3 | 10.3 | 10.3 | 10.3 |
| Electrical | 20 | 21 | 25 | 31 | 36 |
| conductivity(per | | | | | |
| weight percent of | | | | | |
| silica particles) | | | | | |

Results of polishing test
The number of times of circulation: 1

| | | | | | |
|---|---|---|---|---|---|
| Polishing | 3.7 | 3.5 | 3.4 | 3.2 | 3.2 |
| speed(mg/min) | | | | | |
| pH | 10.3 | 10.4 | 10.4 | 10.3 | 10.3 |
| Surface state | Good | Good | Good | Good | Good |

The number of times of circulation: 10

| | | | | | |
|---|---|---|---|---|---|
| Polishing | 3.4 | 3.1 | 3 | 2.9 | 2.8 |
| speed(mg/min) | | | | | |
| pH | 10.2 | 10.0 | 10.0 | 10.1 | 10.1 |
| Surface state | Good | Good | Good | Good | Good |

TABLE 4

| | Comparative Examples | | | | |
|---|---|---|---|---|---|
| | 3 | 4 | 5 | 6 | 7 |
| Slurry | A0 | A0 | B0 | B0 | Colloidal silica |
| Silica concentration(wt %) | 5 | 20 | 5 | 20 | 20 |
| TMAOH(mol/kg-SiO2) | 0.08 | 0.08 | 0.08 | 0.08 | 0.08 |
| TMAHCO3(mol/kg-SiO2) | — | — | — | — | — |
| KHCO3(mol/kg-SiO2) | 0.088 | 0.088 | 0.088 | 0.088 | 0.09 |
| KF(mol/kg-SiO2) | 0.1 | 0.1 | 0.1 | 0.1 | 0.1 |
| pH | 10.4 | 10.3 | 10.3 | 10.3 | 10.3 |
| Electrical | 27 | 27 | 27 | 27 | 27 |
| conductivity(per weight | | | | | |
| percent of silica | | | | | |
| particles) | | | | | |

Results of polishing test
The number of times of circulation: 1

| | | | | | |
|---|---|---|---|---|---|
| Polishing speed(mg/min) | 2.8 | 4.4 | 2.7 | 3.9 | 2 |
| pH | 10.4 | 10.3 | 10.3 | 10.3 | 10.3 |
| Surface state | A large | A large | A large | A large | A large number |
| | number of | number | number of | number | of insufficiently |
| | insufficiently | of | insufficiently | of | polished |
| | polished | scratches | polished | scratches | portions were |
| | portions and | were | portions and | were | observed |
| | scratches | observed | scratches | observed | |
| | were | | were | | |
| | observed | | observed | | |

The number of times of circulation: 10

| | | | | | |
|---|---|---|---|---|---|
| Polishing speed(mg/min) | 2.8 | 4.4 | 2.5 | 3.2 | 1.9 |
| pH | 10.3 | 10.3 | 10.1 | 10.1 | 10.2 |
| Surface state | A large | A large | A large | A large | A large number |
| | number of | number | number of | number | of insufficiently |
| | insufficiently | of | insufficiently | of | polished |
| | polished | scratches | polished | scratches | portions were |
| | portions and | were | portions and | were | observed |
| | scratches | observed | scratches | observed | |
| | were | | were | | |
| | observed | | observed | | |

In the examples shown in Table 3, polishing tests of the edge portion were performed using the following polishing compositions while the polishing compositions were repeatedly circulated. In all the polishing compositions, the ratio A/B was in the range of 1.2 to 2.0, the average particle diameter measured by a laser light-scattering method was in the range of 10 to 50 nm, and the concentration of silica was in the range of 0.5 to 50 weight percent. Furthermore, the polishing compositions contained a buffering solution prepared by combining a weak acid having a logarithm of the reciprocal number of acid dissociation constant at 25° C. in the range of 8.0 to 12.5 with a strong base, and had a buffering action at a pH in the range of 8 to 11. As is apparent from the results of the examples shown in Table 3, when the polishing tests of the edge portion were performed using the above polishing compositions, satisfactory results were stably obtained in terms of both the polishing speed and the surface state, and the surface quality was also satisfactory and no serious defects were observed on the surface. In contrast, as shown in the comparative examples in Table 4, when the polishing compositions having a ratio A/B that was out of the range of the present invention were used, the polished wafers significantly damaged and unsatisfactory results were obtained. Accordingly, when the polishing compositions were used with repeated circulation, stable polishing was not performed and polishing was insufficiently performed. As a result, the original rough surface still remained and was not polished. On the other hand, combination of the fumed silica used in the present invention with spherical silica, which has a ratio A/B of 1.0, such as colloidal silica, compensated for a shortcoming of a low polishing speed of the colloidal silica. When the fumed silica of the present invention is added to colloidal silica even in a small amount, satisfactory polishing speeds and surface states could be obtained.

### <Surface Polishing Test>

### Examples 23 to 32 and Comparative Examples 8 to 11

Mirror polishing tests of a surface portion of semiconductor wafers were performed using polishing compositions of Examples 23 to 32 shown in Table 5 and polishing compositions of Comparative Examples 8 to 11 shown in Table 6, while the polishing compositions were repeatedly circulated.

A machine for polishing a semiconductor wafer used in these tests and polishing conditions therefor are as follows:

Polishing machine: SH-24, manufactured by SpeedFam Co., Ltd.

Rotational speed of surface plate: 70 RPM

Rotational speed of pressure plate: 50 RPM

Polishing cloth: SUBA400 (manufactured by Rodel Nitta Company)

Load: 150 g/cm²

Flow rate of polishing composition: 80 mL/min

Polishing time: 10 minutes

After the completion of the surface polishing, purified water was supplied on the wafer instead of the polishing composition to wash the polishing composition. The wafer was then detached from the polishing machine and underwent brush scrub washing using 1% aqueous ammonia and purified water. Spin drying of the wafer was then performed with nitrogen blowing. The number of particles attached to the surface of the polished wafer and having a size of 0.10 μm or more was determined with a scanning electron microscope (SEM) and a surface inspection apparatus that utilizes a laser light-scattering method. The polishing speed was calculated from the difference between the silicon wafer weight before polishing and the silicon wafer weight after polishing. The polished surface was evaluated by visually observing the state of hazing and pits under a light-collecting lamp.

In all the examples and the comparative examples, neither hazing nor pits were observed, and the number of particles having a size of 0.10 μm or more was 10 or less. As is apparent from the results of the examples shown in Table 5, in the polishing tests of the surface portion performed using the polishing compositions of the present invention, satisfactory polishing speeds were achieved, and thus satisfactory results were obtained. In contrast, as shown in the results of the comparative examples of Table 6, in the experiments using the polishing compositions containing fumed silica particles that had not been ground, although the polishing speeds were higher than those in the examples, a large number of scratches were observed, showing a possibility of unsatisfactory semiconductor performance.

TABLE 5

| | Example | | | | |
|---|---|---|---|---|---|
| | 23 | 24 | 25 | 26 | 27 |
| Slurry | A1 | A1 | A1 | B1 | B1 |
| Silica | 2 | 4 | 4 | 2 | 4 |
| concentration(wt %) | | | | | |
| TMAOH(mol/kg-SiO2) | 0.08 | 0.08 | — | 0.08 | 0.08 |
| TMAHCO3(mol/kg- | 0.088 | — | — | 0.088 | 0.088 |
| SiO2) | | | | | |
| KHCO3(mol/kg-SiO2) | — | 0.088 | — | — | — |
| KF(mol/kg-SiO2) | 0.1 | 0.05 | — | 0.1 | 0.05 |
| pH | 10.3 | 10.3 | 9.1 | 10.2 | 10.2 |
| Electrical | 27 | 22 | 0.9 | 27 | 22 |
| conductivity(per | | | | | |
| weight percent of | | | | | |
| silica particles) | | | | | |

Results of polishing test
The number of times of circulation: 1

| | | | | | |
|---|---|---|---|---|---|
| Polishing | 0.33 | 0.41 | 0.35 | 0.3 | 0.4 |
| speed(mg/min) | | | | | |
| pH | 10.3 | 10.3 | 9.0 | 10.2 | 10.2 |
| Surface state | Good | Good | Good | Good | Good |

The number of times of circulation: 10

| | | | | | |
|---|---|---|---|---|---|
| Polishing | 0.31 | 0.37 | 0.29 | 0.3 | 0.38 |
| speed(mg/min) | | | | | |
| pH | 10.3 | 10.1 | 8.6 | 10.1 | 10.0 |
| Surface state | Good | Good | Good | Good | Good |

| | Example | | | | |
|---|---|---|---|---|---|
| | 28 | 29 | 30 | 31 | 32 |
| Slurry | C1 | C2 | C3 | C4 | C5 |
| Silica | 2 | 2 | 2 | 2 | 2 |
| concentration(wt %) | | | | | |
| TMAOH(mol/kg-SiO2) | 0.08 | 0.08 | 0.08 | 0.08 | 0.08 |
| TMAHCO3(mol/kg- | 0.088 | 0.088 | 0.088 | 0.088 | 0.088 |
| SiO2) | | | | | |
| KHCO3(mol/kg-SiO2) | — | — | — | — | — |
| KF(mol/kg-SiO2) | 0.026 | 0.026 | 0.026 | 0.026 | 0.026 |
| pH | 10.1 | 10.1 | 10.1 | 10.1 | 10.1 |
| Electrical | 20 | 21 | 25 | 31 | 36 |
| conductivity(per | | | | | |
| weight percent of | | | | | |
| silica particles) | | | | | |

Results of polishing test
The number of times of circulation: 1

| | | | | | |
|---|---|---|---|---|---|
| Polishing | 0.29 | 0.27 | 0.27 | 0.26 | 0.26 |
| speed(mg/min) | | | | | |
| pH | 10.1 | 10.1 | 10.1 | 10.1 | 10.1 |
| Surface state | Good | Good | Good | Good | Good |

The number of times of circulation: 10

| | | | | | |
|---|---|---|---|---|---|
| Polishing | 0.28 | 0.27 | 0.26 | 0.26 | 0.25 |
| speed(mg/min) | | | | | |
| pH | 9.8 | 9.9 | 10.0 | 10.1 | 10.1 |
| Surface state | Good | Good | Good | Good | Good |

TABLE 6

| | Comparative Examples | | | |
|---|---|---|---|---|
| | 8 | 9 | 10 | 11 |
| Slurry | A0 | A0 | B0 | B0 |
| Silica | 2 | 4 | 2 | 4 |
| concentration(wt %) | | | | |
| TMAOH(mol/kg-SiO2) | 0.08 | 0.08 | 0.08 | 0.08 |
| TMAHCO3(mol/kg- | 0.088 | — | 0.088 | 0.088 |
| SiO2) | | | | |
| KHCO3(mol/kg-SiO2) | — | 0.088 | — | — |
| KF(mol/kg-SiO2) | 0.1 | 0.1 | 0.1 | 0.1 |
| pH | 10.3 | 10.3 | 10.2 | 10.2 |
| Electrical | 27 | 27 | 27 | 27 |
| conductivity(per | | | | |
| weight percent of | | | | |
| silica particles) | | | | |

Results of polishing test
The number of times of circulation: 1

| | | | | |
|---|---|---|---|---|
| Polishing | 0.48 | 0.68 | 0.42 | 0.59 |
| speed(mg/min) | | | | |
| pH | 10.3 | 10.3 | 10.2 | 10.2 |
| Surface state | A large | A large | A large | A large |
| | number of | number of | number of | number of |
| | scratches | scratches | scratches | scratches |
| | were | were | were | were |
| | observed | observed | observed | observed |

The number of times of circulation: 10

| | | | | |
|---|---|---|---|---|
| Polishing | 0.47 | 0.61 | 0.38 | 0.5 |
| speed(mg/min) | | | | |
| pH | 10.1 | 9.9 | 10.0 | 10.0 |
| Surface state | A large | A large | A large | A large |
| | number of | number of | number of | number of |
| | scratches | scratches | scratches | scratches |
| | were | were | were | were |
| | observed | observed | observed | observed |

### Example 33

### A Grinding Example in which a Slurry is Passed Through a Bead Mill Twice Using Beads Having a Diameter of 0.1 mm

Tetramethylammonium hydroxide was added to 75 parts by weight of purified water in an amount of 0.15 mol relative to 1 kg of silica, and mixing was performed under stirring. Subsequently, 25 parts by weight of the same fumed silica particles as those used in Slurry A of the above examples (BET specific surface area: 90 m²/g) were added to the mixture and dispersed by agitation. Thus, a slurry containing 25 weight percent of silica was prepared. The pH of this slurry was 10.23, and the BET specific surface area of the silica particles in the slurry was 95 m²/g. The average ratio A/B of the major axis A to the minor axis B of the silica particles measured by TEM observation was 5. The average particle diameter measured by the laser light-scattering method was 266 nm.

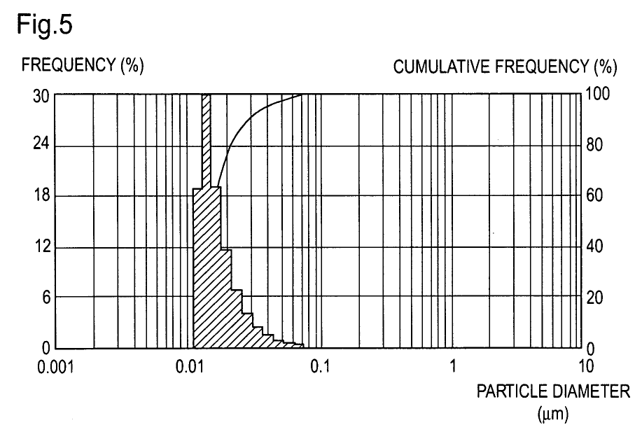

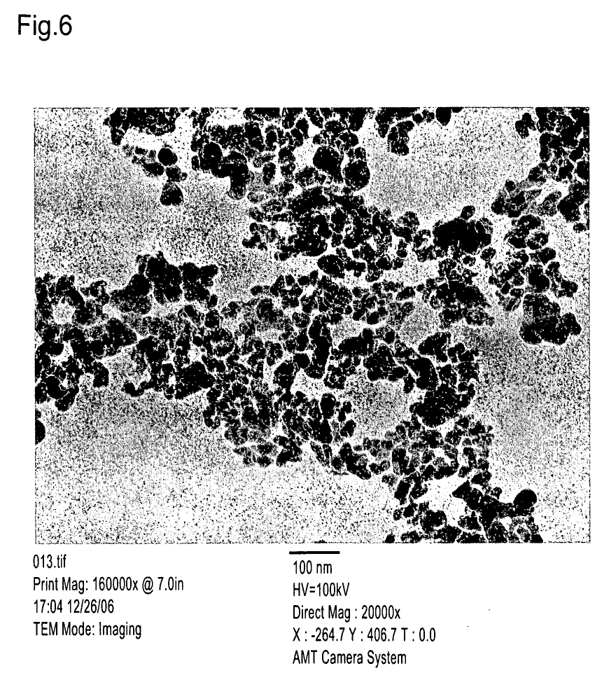

Subsequently, this slurry was ground with a bead mill (LMZ 2: manufactured by Ashizawa Finetech Ltd.) using zirconia beads having a diameter of 0.1 mm as a grinding medium at a slurry flow rate of 200 mL/min and at 2,000 rpm. The ground slurry was again ground under the same conditions. The pH of the slurry ground by allowing the slurry to pass through the bead mill twice was 9.0, and the BET specific surface area of the silica particles in the slurry was 184 m²/g. The major axis A of the particles measured by TEM observation was 33.7 nm, and the minor axis B thereof was 27.6 nm. The average ratio A/B was 1.22. The average particle diameter measured by the laser light-scattering method was 15.4 nm. FIG. 5 shows the particle size distribution of the silica particles in this slurry, and FIG. 6 shows a TEM image of the silica particles in this slurry.

### Example 34

### A Grinding Example Using Beads Having a Diameter of 0.2 mm

Tetramethylammonium hydroxide was added to 75 parts by weight of purified water in an amount of 0.15 mol relative to 1 kg of silica, and mixing was performed under stirring. Subsequently, 25 parts by weight of commercially available fumed silica particles (BET specific surface area: 90 m²/g) were added to the mixture and dispersed by agitation. Thus, a slurry containing 25 weight percent of silica was prepared. The pH of this slurry was 10.23, and the BET specific surface area of the silica particles in the slurry was 95 m²/g. The average ratio A/B of the major axis A to the minor axis B of the silica particles measured by TEM observation was 5. The average particle diameter measured by the laser light-scattering method was 266 nm.

Subsequently, this slurry was ground with a bead mill (LMZ 2: manufactured by Ashizawa Finetech Ltd.) using zirconia beads having a diameter of 0.5 mm as a grinding medium at a slurry flow rate of 150 mL/min and at 2,000 rpm. The pH of this slurry was 9.8, and the average particle diameter measured by the laser light-scattering method was 208 nm. Subsequently, the ground slurry was again ground under the same conditions as those described above except that zirconia beads having a diameter of 0.2 mm were used. The pH of the resulting slurry was 9.5, and the average particle diameter measured by the laser light-scattering method was 98 nm. Subsequently, this slurry was further ground by allowing the slurry to pass through the bead mill twice using the above beads having a diameter of 0.2 mm. The pH of the resulting slurry was 9.2, and the specific surface area of the silica particles in the slurry was 122 m²/g. The average ratio A/B of the major axis A to the minor axis B of the silica particles measured by TEM observation was 1.8. The average particle diameter measured by the laser light-scattering method was 47 nm.

### Comparative Example 12

### A Grinding Example Using a Sand Grinder, which is Different from the Present Invention

First, 15 parts by weight of commercially available fumed silica particles having a BET specific surface area of 130 m²/g and a ratio A/B of 10 were added to 70 parts by weight of purified water and dispersed therein by agitation. A slight amount of tetramethylammonium hydroxide was added to the dispersion to adjust the pH of the dispersion to be 8. Subsequently, 300 mL of this slurry having a high viscosity was charged in a vessel of a sand grinder (4TSG-1/4, manufactured by Aimex Co., Ltd.), and grinding was performed at 2,000 rpm for one hour using zirconia beads having a diameter of 0.5 mm as a grinding medium. After the grinding, the content was taken out from the sand grinder. The zirconia beads were removed with a sieve, and the ground slurry was recovered. The ground slurry had a low viscosity. Subsequently, 15 parts by weight of fumed silica particles were again added to the slurry and dispersed by agitation. A slight amount of tetramethylammonium hydroxide was added to the dispersion to adjust the pH of the dispersion to be 8 again. The grinding using the sand grinder was again performed for one hour. The zirconia beads were then removed with a sieve, and the ground slurry having a silica concentration of 30% was recovered. The pH of the slurry was slightly decreased due to an acid component of the fumed silica particles. Therefore, the pH of the slurry was again adjusted to 8 by adding a slight amount of tetramethylammonium hydroxide.

The BET specific surface area of the silica particles in the resulting slurry was 160 m²/g. The ratio A/B thereof was 5. The average particle diameter measured by the laser light-scattering method thereof was 75 nm. Accordingly, a desired slurry could not be obtained. Although the resulting slurry was again ground under the condition that the grinding time was increased by two times and four times, the average particle diameter measured by the laser light-scattering method was 72 nm and 70 nm, respectively. Accordingly, a desired slurry could not be obtained.

### Comparative Example 13

### A Grinding Example which is Different from the Present Invention and in which Fumed Silica Particles Having a Different Specific Surface Area are Used

Tetramethylammonium hydroxide was added to 75 parts by weight of purified water in an amount of 0.15 mol relative to 1 kg of silica, and mixing was performed under stirring. Subsequently, 25 parts by weight of commercially available fumed silica particles (BET specific surface area: 50 m²/g) were added to the mixture and dispersed by agitation. Thus, a slurry containing 25 weight percent of silica was prepared. The pH of the slurry was 10.3, and the BET specific surface area of the silica particles in the slurry was 42.9 m²/g. The average ratio A/B of the major axis A to the minor axis B of the silica particles measured by TEM observation was 10. The average particle diameter measured by the laser light-scattering method was 290 nm.

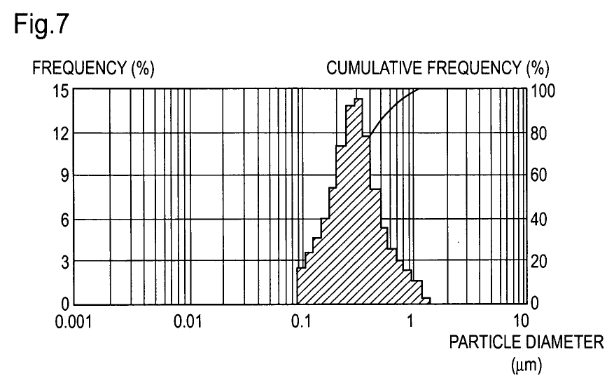

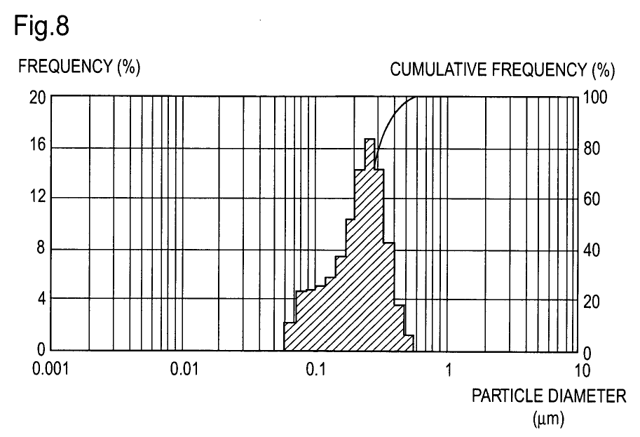

This slurry was ground with a bead mill (LMZ 2: manufactured by Ashizawa Finetech Ltd.) using zirconia beads having a diameter of 0.5 mm as a grinding medium at a slurry flow rate of 150 mL/min and at 2,000 rpm. The pH of the ground slurry was 10.1, and the BET specific surface area of the silica particles in the slurry was 45.4 m²/g. The average ratio A/B of the major axis A to the minor axis B of the silica particles measured by TEM observation was 5. The average particle diameter measured by the laser light-scattering method was 228 nm. FIG. 7 shows the particle size distribution before the grinding, and FIG. 8 shows the particle size distribution after the grinding.

### Example 35

### A Method Including Mixing a Buffering Solution with Fumed Silica Particles, and Grinding the Resulting Slurry by a Wet Process

Preparation of Slurry D: Tetramethylammonium Hydroxide was added to 73 parts by weight of purified water in an amount of 0.10 mol relative to 1 kg of silica, and mixing was performed under stirring. Subsequently, tetramethylammonium hydrogencarbonate was added to the mixture in an amount of 0.11 mol relative to 1 kg of silica, and mixing was performed under stirring. Thus, a pH buffering solution was prepared. Subsequently, 25 parts by weight of commercially available fumed silica particles (BET specific surface area: 90 m²/g) were added to the pH buffering solution and dispersed by agitation. Thus, a slurry containing 25 weight percent of silica was prepared. This slurry is referred to as Slurry D0. The pH of Slurry D0 was 10.5, and the BET specific surface area of the silica particles in the slurry was 95 m²/g. The average ratio A/B of the major axis A to the minor axis B of the silica particles measured by TEM observation was 5. The average particle diameter measured by the laser light-scattering method was 269 nm.

Subsequently, this slurry was ground with a bead mill (LMZ 2: manufactured by Ashizawa Finetech Ltd.) using zirconia beads having a diameter of 0.1 mm as a grinding medium at a slurry flow rate of 150 mL/min and at 2,000 rpm. This ground slurry is referred to as Slurry D1.

The pH of Slurry D1 was 10.3, and the BET specific surface area of the silica particles in the slurry was 127 m²/g. The major axis A of the particles measured by TEM observation was 57.1 nm, and the minor axis B thereof was 37.3 nm. The average ratio A/B was 1.53. The average particle diameter measured by the laser light-scattering method was 25.9 nm.

As described above, although the change in the BET specific surface area due to the grinding was not significant, the ratio A/B of the major axis A to the minor axis B of the silica particles was markedly decreased. This result showed that the shape of the particles was changed to a cubic shape by the grinding. The average particle diameter measured by the laser light-scattering method also reflected this state, and showed that not only secondary agglomeration was undone but also grinding of primary particles occurred.

A description of grinding of fumed silica particles has been made. In the examples described above, batch-type grinding, such as first grinding or second grinding, was performed. In general, however, in wet grinding using a grinding medium, the grinding is often performed while a slurry is circulated through a slurry storage tank and a grinding apparatus. The grinding performed in the present invention is not limited to the batch-type grinding.

What is claimed is:

1. A composition for polishing a semiconductor wafer comprising:
fumed silica particles that are produced by wet grinding using a grinding medium and that have characteristics (A) to (C):
(A) a specific surface area in the range of 50 to 200 m²/g measured by a BET method;
(B) an average particle diameter in the range of 10 to 50 nm measured by a laser light-scattering method; and
(C) an average ratio A/B of the major axis A to the minor axis B of the fumed silica particles in the range of 1.2 to 2.0 measured by TEM observation,
wherein the concentration of silica particles containing the fumed silica particles is in the range of 0.5 to 50 weight percent relative to the total weight of an aqueous dispersion.

2. The composition for polishing a semiconductor wafer according to claim 1, further comprising:
colloidal silica particles,
wherein the concentration of the fumed silica particles is in the range of 0.5 to 10 weight percent relative to the total weight of the aqueous dispersion, and
the total concentration of the silica particles is in the range of 0.5 to 50 weight percent relative to the total weight of the aqueous dispersion.

3. The composition for polishing a semiconductor wafer according to claim 1, further comprising:
a base,
wherein the pH of the composition at 25° C. is in the range of 8 to 11.

4. The composition for polishing a semiconductor wafer according to claim 1, further comprising:
a buffering solution prepared by combining a weak acid having a logarithm (pKa) of the reciprocal number of acid dissociation constant at 25° C. in the range of 8.0 to 12.5 with a strong base,
wherein the composition has a buffering action at a pH in the range of 8 to 11.

5. The composition for polishing a semiconductor wafer according to claim 4,
wherein an anion forming the weak acid is a carbonate ion or a hydrogen carbonate ion, and
a cation forming the strong base is at least one ion selected from an alkali metal ion, a choline ion, a tetramethylammonium ion, and a quaternary ammonium ion.

6. The composition for polishing a semiconductor wafer according to claim 4,
wherein the electrical conductivity of the composition at 25° C. is at least 20 mS/m per weight percent of silica particles.

7. The composition for polishing a semiconductor wafer according to claim 1,
wherein the wet grinding using a grinding medium is bead mill grinding using spherical beads having a diameter in the range of 0.02 to 0.2 mm as the grinding medium.

8. A method of producing the composition for polishing a semiconductor wafer according to claim 4, comprising the steps of:
mixing an aqueous solution of a strong base with fumed silica particles;
wet-grinding the mixture;
adding a weak acid to the ground mixture to prepare a buffering solution; and
wet-grinding the buffering solution.

9. A method of producing the composition for polishing a semiconductor wafer according to claim 4, comprising the steps of:
mixing fumed silica particles with an aqueous solution that contains a weak acid and a strong base and that has a buffering action at a pH in the range of 8 to 11; and
wet-grinding the mixture.

10. The method of producing a composition for polishing a semiconductor wafer according to claim 8
wherein the wet grinding using a grinding medium is bead mill grinding using spherical beads having a diameter in the range of 0.02 to 0.2 mm as the grinding medium.
